(19) United States
(12) Patent Application Publication
(10) Pub. No.: US 2008/0069475 A1
(43) Pub. Date: Mar. 20, 2008

(54) Video Pattern Thumbnails and Method

(76) Inventor: Simon Ekstrand, Ekgarden (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/532,577

(22) Filed: Sep. 18, 2006

(51) Int. Cl. G06K 9/36

(52) U.S. Cl. 382/284

(57) ABSTRACT

An electronic equipment and method for creating a composite image or video pattern thumbnail from frame data extracted from a media file. The electronic equipment includes a control circuit operable to access a media file comprised of frame data representing a plurality of image frames. The electronic equipment also may have a processor for extracting a portion of the frame data from each of the plurality of frames and for forming the composite image from the extracted data. The composite image, or video pattern thumbnail, is representative of the content of the media file.

### TECHNICAL FIELD OF THE INVENTION

The present invention relates generally to video or image processing and electronic equipment, such as electronic equipment for engaging in voice communications.

### BACKGROUND

The use of thumbnail images is common in the computer industry. Thumbnails generally are small graphical representations of the contents of a media file, such as an image file. By viewing the thumbnail, a user may be able to determine the content of the media file without opening the file. Conventional thumbnails, however, are less useful when used to depict the contents of a non-image file, such as a video file. A conventional thumbnail of a video file may be comprised of a single image representative of a frame from the video file. Because the video file may contain tens of thousands of frames or more, a representation of a single frame from the video is not very useful for identifying the content of the media file.

### SUMMARY

In one embodiment, an electronic equipment having a control circuit having access to a media file, the media file comprising frame data for a plurality of frames wherein the frame data for each of the plurality of frames represents a corresponding image comprising an array of pixel data and a processor for extracting a portion of the frame data from each of the plurality of frames to produce data representing a composite image, the composite image comprising portions of frame data from each of the plurality of frames.

In another embodiment, the plurality of frames are in a chronological order.

In another embodiment, the extracted portion of the frame data from each frame comprises a column of pixel data from the array of pixel data for the frame.

In another embodiment, the data representing the composite image comprises columns of pixel data from each of the plurality of frames arranged side-by-side and in chronological order.

In another embodiment, the electronic equipment having a display to view the composite image.

In another embodiment, the display has a display area comprised of an array of pixels.

In another embodiment, the array of pixels is comprised of a plurality of pixel columns.

In another embodiment, the number of columns of pixel data is the same as the number of columns of pixels in the display.

In another embodiment, the electronic equipment having a display to view the composite image.

In another embodiment the electronic equipment further comprises a media library for storing a media files to view on the display.

In another embodiment, the medial library comprises the composite images for the medial files in the media library.

In another embodiment, the media library further comprises a progress bar for indicating the portions of the media file that have been accessed by a media player.

In another embodiment, each array of pixel data comprises a plurality of rows of pixel data and the extracted portions of the frame data represent the dominant color of the pixel data from each row.

In another embodiment, the data representing the composite image comprises a plurality of columns of pixel data arranged side-by-side and in a chronological order.

In another embodiment, the electronic equipment has a display to view the composite image.

In another embodiment, the media file comprises a video file.

In another embodiment, the media file comprises a sequence of image files.

In another embodiment, the media file representative of an audio file.

In another embodiment, the electronic equipment is a mobile communication device.

In another embodiment, a method of creating an image including the steps of accessing a media file, the media file comprising frame data for a plurality of frames wherein the frame data for each of the plurality of frames represents a corresponding image comprising an array of pixel data and extracting a portion of the frame data from each of the plurality of frames to produce data representing a composite image, the composite image comprising portions of frame data from each of the plurality of frames.

In another embodiment, the step of extracting frame data comprises extracting a column of pixel data from each of the plurality of frames.

In another embodiment, the method includes the step of arranging the pixel data side-by-side in chronological order.

In another embodiment, the method further includes the step of displaying the composite image on a display.

In another embodiment, the step of displaying the composite image comprises displaying the composite image on a screen comprised of an array of pixels.

In another embodiment, the step of displaying further comprises displaying the composite image with a screen comprised of an array of pixels having a plurality of pixel columns.

In another embodiment, the step of displaying the composite image on the screen further comprises displaying each extracted column of pixel data with a corresponding pixel column on the screen.

In another embodiment, the method includes the step of indicating the portions of a media file that have been accessed by a media player function.

In another embodiment, a program stored on a machine readable medium which, when executed by a machine, provides for the creation of an image by accessing a media file, the media file comprising frame data for a plurality of frames wherein the frame data for each of the plurality of frames represents a corresponding image comprising an array of pixels and extracting a portion of the frame data from each of the plurality of frames to produce data representing a composite image comprised of portions of frame data from each of the plurality of frames.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments. It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is an electronic equipment displaying the contents of a media library with a display.

FIG. 2 is a series of frames representative of the content of a media file.

FIG. 3 is the series of frames of FIG. 2 used to create a composite image.

FIG. 4A is representative of a single frame from a media file.

FIG. 4B is representative of an extracted portion of pixel data from the frame of FIG. 4A.

FIG. 5 is a flow chart representing the steps for processing the media file to create the composite image.

FIG. 6 is an exemplary embodiment of a mobile telephone.

FIG. 7 is a schematic block diagram of the relevant portions of the mobile telephone of FIG. 6.

FIG. 8 is a schematic diagram of a communications system in which the mobile telephone of FIG. 6 may operate.

### DETAILED DESCRIPTION OF EMBODIMENTS

In the following description, with reference to the drawings, like reference numerals are used to refer to like elements throughout. It will be appreciated that the drawings are not necessarily to scale. In the present application, the invention is described primarily in the context of electronic equipment and specifically, a mobile telephone. It will be appreciated, however, that the invention is not intended to be limited to a mobile telephone and can be any type of electronic equipment. The term “electronic equipment” includes portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatuses or the like.

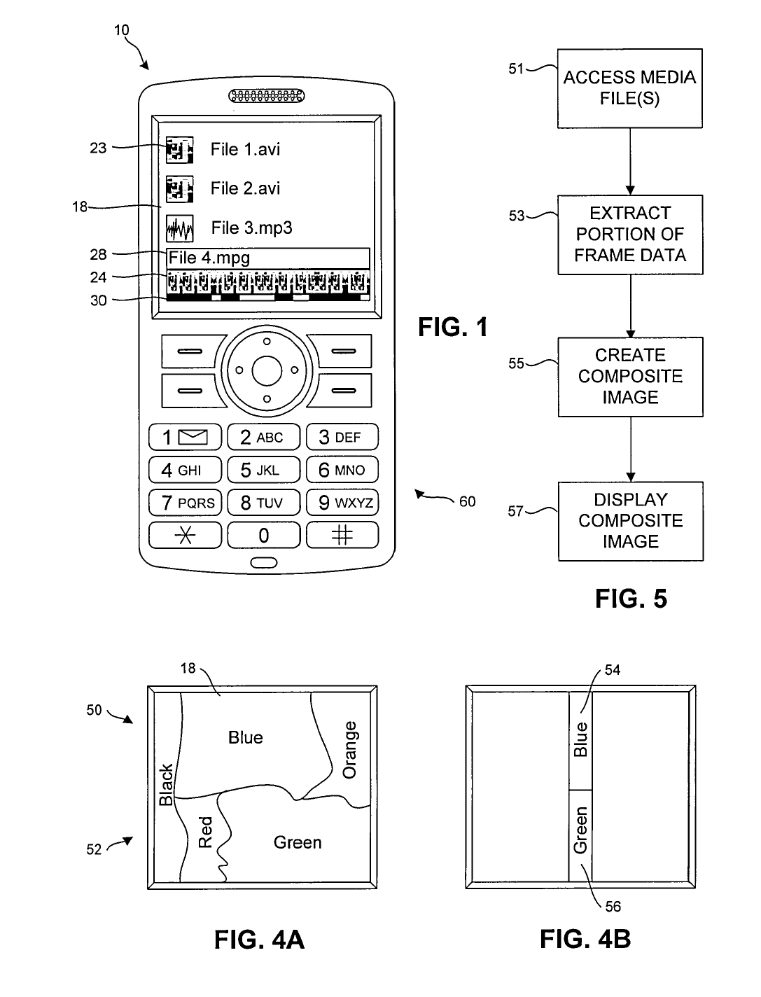

An electronic equipment 10 is shown in FIG. 1. The electronic equipment 10 is a mobile radio terminal and, in particular, a mobile telephone 10. Thus, the electronic equipment will be referred to as the mobile telephone 10.

The functionality of the mobile telephone 10 will be described in more detail below. Referring briefly to FIG. 7, the mobile telephone 10 comprises a control circuit 12, a processor or video processing circuit 13 and access to a media library 14. The control circuit 12 is operable to control the video processing circuit 13 and the display to play media files 16 on the mobile telephone 10.

Each media file 16 accessed in or stored by the media library 14 is programmed to include information about the media file, such as, for example, frame data 20 and information regarding the artist, title, and format, etc. The media file 16 is comprised of frame data 20 representing a plurality of frames for displaying the media file 16 on the display 18. The frame data 20 is comprised of an array of pixel data 22 for each respective frame. The pixel data 22 is processed by the video processing circuit 13 to create a graphical representation of the frame on the display 18.

The video processing circuit 13 is operable to process the frame data 20 to create a composite image 24 or video pattern thumbnail, which is comprised of a portion of the pixel data 22 for each of the plurality of frames in the media file 16. The composite image 24 therefore represents a unique representation of the content of the media file 16, such as the overall feel, colorization, light, tempo, etc. of the media file 16.

Referring again to FIG. 1, the contents of the media library 14 (or the files to which the media library might have access) are shown in a menu on the display 18. The menu in FIG. 1 is an expandable/collapsible menu. In the collapsed state, the menu displays a thumbnail 23 and the title 28 of each media file 16. When the menu is expanded, the composite image 24, the title 28 of the media file 16 and a progress bar 30 are displayed. The progress bar 30 is a graphical depiction of the portions of the media file 16 that have been accessed, listened to, or played by the video processing circuit 13, for example, with a media player. With regard to the media file entitled “File 4.mpg”, the color of the progress bar 30 has been changed by the video processing circuit 13 to indicate the portions of the file that have been accessed or played. The portions of the file that have not been played are colored white, while the portions of the file that have been played are colored black. The user can then easily determine which portions of the file have not been accessed and begin viewing the file at that point. If the media file 16 is an audio file, the progress bar 30 indicates which chapters or portions have been listened to and which have not, allowing a user to begin listening to the file where he or she previously stopped.

Although the display 18 of FIG. 1 depicts the thumbnail 23, the file name 28, composite image 24 and a progress bar 30 for each of the media files 16, in the collapsed and/or expanded state, it will be appreciated that the control circuit 12 may be programmed to control the menu to display more, less, or different information, or to customize the menu as desired.

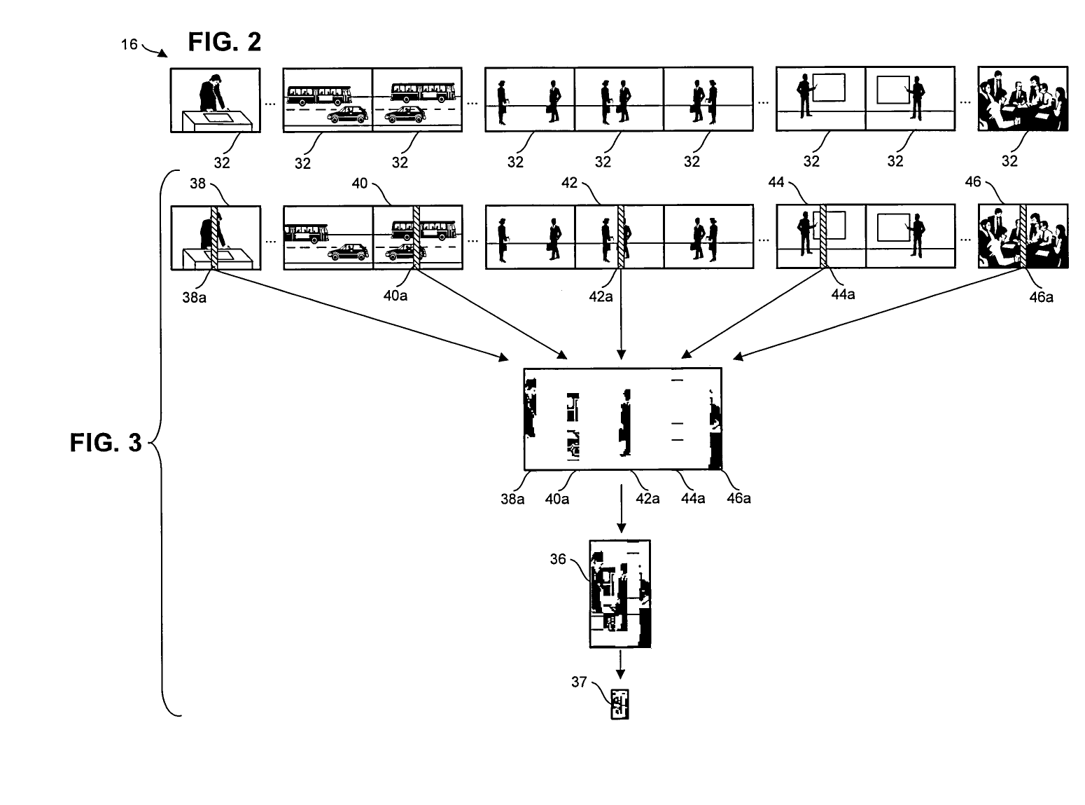

An example of a media file 16, such as a video file, is shown in FIG. 2. The media file 16 is comprised of a plurality of frames 32 arranged in chronological order. Each frame of the media file 16 is comprised of frame data 20 for displaying the frames 32 on the display 18. The frame data 20 is comprised of an array of pixel data 22, which is processed by the video processing circuit 13 to create a graphical representation of the frame 32 on the display 18.

The media files 16, especially video and audio files, may contain large amounts of data and may be compressed by various compression techniques that are well known in the art, including, for example, intraframe compression, interframe compression, lossless compression, etc. If the media file 16 has been compressed, the frame data 20 for each individual frame may not include a full set of pixel data 22 for representing an image or frame. In other words, the frame data 20 may contain only a portion of the data necessary for showing the frame on the display 18. When the compressed frame data is processed in conjunction with frame data 20 from the rest of the media file 16, however, a full image can be obtained. Thus, it will be appreciated by one of skill in the art that a full image may be obtained from the frame data 20 from any given frame if the frame data 20 is processed in conjunction with additional frame data 20 in the media file 16. The apparatus and processes described herein are equally applicable to both compressed and uncompressed media files, including video and image files, etc.

Referring to FIG. 3, the video processing circuit 13 is programmed to create the composite image 36 by extracting portions of pixel data 22 from the media file 16 of FIG. 2. In the embodiment of FIG. 3, a column of pixel data from each of the plurality of frames 38, 40, 42, 44, 46 in the video file 16 is extracted to create the composite image 36. For example, a column of pixel data 38a is extracted from frame 38. Likewise, a column of pixel data 40a is extracted from frame 40, etc., until columns of pixel data 38a, 40a, 42a, 44a, 46a are extracted from each of the plurality of frames 38, 40, 42, 44, 46. For purposes of illustration, the extracted portions of pixel data 38a, 40a, 42a, 44a, 46a are depicted as shaded regions in FIG. 3; however, it will be appreciated that the frame data 20 and the image represented by the frame data 20 are not altered when the pixel data is extracted.

The video processing circuit 13 is also programmed to arrange the extracted portions 38a, 40a, 42a, 44a, 46a of the plurality of frames 38, 40, 42, 44, 46 side-by-side in chronological order to form the composite image 36. The composite image 36 may then be vertically compressed to create a reduced-size composite image 37, which may be used in the expandable/collapsible menu of FIG. 1.

Although only a few frames are shown in FIG. 3, the video processing circuit 13 is operable to extract pixel data 22 from any number of frames 32. For example, the plurality of frames 32 may be determined or based upon the total number of frames in the media file 16 or video file and the size of the display 18. For example, if the video file contains frame data 20 for 2400 frames and the display 18 is 240 pixels wide, then the video processing circuit 13 is programmed to extract pixel data from 240 even spaced frames, or in this example, every hundredth frame to create the composite image 36. Because the display is 240 pixels wide and data is extracted from 240 frames, one column of pixel data is extracted per frame and for assembling to create the composite image. Thus, the video processing circuit 13 is programmed to extract a single column of pixel data 22 from each of the 240 frames and combine the pixel data side-by-side in chronological order, as described above, to create the composite image 36.

Alternatively, the video processing circuit 13 may be programmed to extract pixel data from 120 frames rather than 240 frames, in which case two columns of pixel data would be extracted from each of the plurality of frames. Similarly, if the display is 480 pixels wide, the plurality of frames from which pixel data is extracted could be 480 frames, or the columns of pixel data could be 4 pixels wide, if data from 120 frames were extracted.

It will be appreciated that the values used above for the number of frames in the video file and the display size are only illustrative, and the video processing circuit 13 and the broad concepts described herein are applicable to media files having any number of frames and for displays of any size or resolution.

Generally, the center portion of each video frame in a video file contains the most relevant subject matter, i.e., it typically is the focus of the viewer's attention. The pixel data 22 for the upper, lower and side regions of the frame therefore is less likely to contain the most relevant subject matter. The video processing circuit 13 is programmed to extract the pixel data 22 from the center of the frames rather than the pixel data near the borders of the frames to increase the likelihood that the extracted portions of pixel data will contain relevant portions of the frames. As shown in FIG. 3, the extracted portions 38a, 40a, 42a, 44a, 46a of pixel data represent columns of frame data 20 from the center of each of the plurality of frames 38, 40, 42, 44, 46. The composite image 36 is therefore formed from pixel data 22 that is representative of columns of pixel data that are the most likely to contain relevant portions of the video file 16. The video processing circuit 13 also is operable to crop the upper and lower portions of each column of pixel data as well. Alternatively, the video processing circuit 13 may be programmed to compress the columns of pixel data to reduce the height of the composite image 36, thereby ensuring that the composite image is formed from the pixel data likely to contain the most relevant portions of the video file.

Although the example depicted in FIGS. 2-3 is black in white, it will be appreciated that the description herein is equally applicable to color media files. For example, a video file that begins with scenes in a jungle, followed by scenes on a beach or in an ocean and concludes with scenes in a jungle could have a video pattern thumbnail with shades of greens and browns, then blues and whites, and then greens and browns again. A movie that is generally dark and gory may have a video pattern thumbnail that is comprised of pixel data representative of dark colors and shades of red. In another example, the media file may be an audio file with the video processing circuit 13 operable to create a graphical representation of the content of the audio file, such as, for example, frame data representative of a waveform. The video processing circuit 13 would then extract the frame data from the plurality of frames representing the waveform to create the composite image, as described above.

Referring to FIG. 4A, in another embodiment, the frame data 20 comprises pixel data 22 for multiple colors displayed at the same time, as is typical of a video file or movie. The video processing circuit 13 is operable to process the frame data 20 from the plurality of frames to determine the most dominant color for each row of pixel data in the pixel array. The video processing circuit 13 is programmed to extract the pixel data 22 corresponding to the most dominant color in each row of frame data 20 to create a vertical column of pixel data. For purposes of simplification in FIG. 4A, several different colors are shown as blocks of color on the display 18. The dominant color of the top portion 50 of the display 18 is blue while the dominant color of the bottom portion 52 of the display 18 is green.

FIG. 4B is representative of the column of pixel data created by the video processing circuit 13 after determining the most dominant colors of pixel data in each row of the pixel array. The upper portion 54 of the column of pixel data is blue, while the lower portion 56 of the column of pixel data is green. The video processing circuit 13 is programmed to process each of the plurality of frames of the video file in same manner until each of the plurality of frames has been processed. The extracted pixel data is then arranged side-by-side in chronological order, as described above, to create a composite image representative of the content of the video or other media file.

It will be appreciated that instead of columns of pixel data, the extracted portions of pixel data may be comprised of rows of pixel data, or squares of pixel data, etc. Also, instead of side-by-side chronological order, the extracted portions of pixel data may be arranged in a checkerboard pattern or another pattern or orientation, etc.

Referring now to FIG. 5, a flowchart illustrates the operation of the video processing circuit 13 as it is programmed to create the composite image 36. In Step 51, the video processing circuit 13 is programmed to access a media file 16 from the media library 14. The media files 16 may be stored within the memory of the mobile telephone or located remote from the mobile telephone 10 and accessed via a radio circuit 72 (FIG. 7). Each media file is comprised of a plurality of frames, each having frame data 20 comprised of an array of pixel data 22 for displaying the frame on the display 18.

In Step 53, the video processing circuit 13 is programmed to extract a portion of the frame data 20 from each of the plurality of frames in the media file 16. The plurality of frames may be determined by the total number of pixels comprising the width of the display 18. For example, if the display is 240 pixels wide, then the video processing circuit 13 would be programmed to select 240 frames from the media file 16, or one column of pixel data per pixel column on the display 18. As described above, the video processing circuit 13 also may be programmed to accommodate displays of varying size and resolution and/or video files of varying lengths. Further, the size of the extracted potions of pixel data may be dependent on such factors as the resolution of the display, the length of the media file, etc., as described above.

In Step 53, the video processing circuit 13 is programmed to extract a portion of the pixel data 22 from each of the plurality of frames in Step 51. In one embodiment, the extracted pixel data is comprised of a column of pixel data as described above. In other embodiments, the extracted pixel data may be comprised of rows of pixel data, squares of pixel data, etc., or any other variation that may be likely to be representative the relevant content of the frame data 20 for the selected frame.

Referring to Step 55, the video processing circuit 13 is programmed to arrange the extracted pixel data to create the composite image. The columns of extracted pixel data are arranged side-by-side in chronological order to create a composite image that is representative of the content of the media file 16. The extracted pixel data also may be arranged in different orientations, such as a horizontal line, or a checkerboard pattern, etc. The video processor also may be programmed to reduce the size of the composite image, or to vertically compress the composite image to create a smaller or reduced-size composite image.

In Step 57, the video processing circuit 13 is programmed to display the composite image on the electronic equipment as part of a menu for displaying the contents of the media library 14. The display 18 may include the composite image, the name of the media file, the progress bar, etc., such that a user can easily discern the content of the media file by looking at the composite image and/or other information contained in the menu and shown on the display 18.

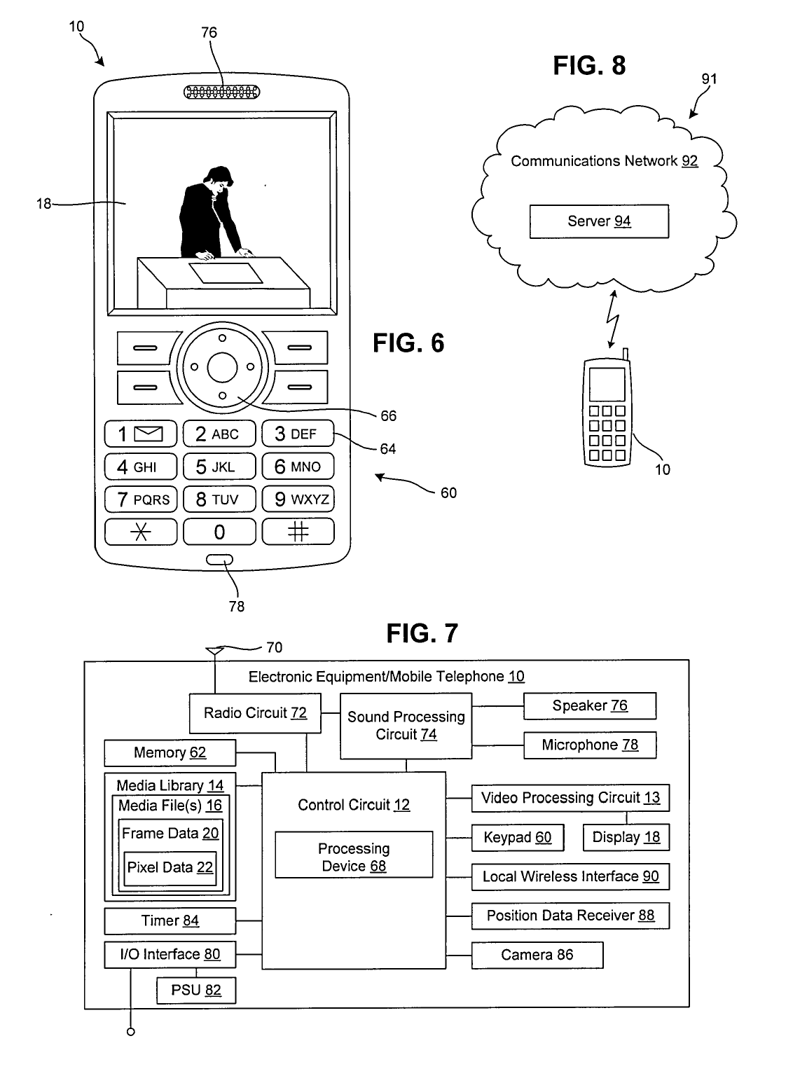

Referring to FIG. 6, the mobile telephone 10 also includes a display 18 and keypad 60. As is conventional, the display 18 displays information to a user such as operating state, time, telephone numbers, contact information, various navigational menus, etc., which enable the user to utilize the various features of the mobile telephone 10. The display 18 is also used to visually display content received by the mobile telephone 10 and/or retrieved from a memory 62 of the mobile telephone 10. In addition, a phone number or a text message entered by the user may be displayed on the display 18 as part of a graphical user interface (GUI).

The keypad 60 may be conventional in that it provides for a variety of user input operations. For example, the keypad 60 typically includes alphanumeric keys 64 for allowing entry of alphanumeric information such as telephone numbers, phone lists, contact information, notes, etc. In addition, the keypad 60 may include special function keys such as a “call send” key for initiating or answering a call, and a “call end” key for ending or hanging up, or disconnecting a phone call.

The keypad 60 also may contain special function keys, which may include menu navigation keys 66, for example, for navigating through a menu displayed on the display 18 such as the media library 14, contact list, etc., or to select different telephone functions, profiles, settings, etc., as is conventional. Other keys associated with the mobile telephone 10 may include a volume key, an audio mute key, an on/off power key, a web browser launch key, a camera key, etc. Keys or key-like functionality also may be embodied as a touch screen associated with the display 18. The keys 64 may be used to enter written text (e.g., a string of alphanumeric characters) and to operate GUI menus, or to adjust or modify the mobile telephone settings, such as, for example, the brightness of the display, audio volume, etc.

The mobile telephone 10 includes conventional call circuitry that enables the mobile telephone 10 to establish a call and/or exchange signals with a called/calling device, typically another mobile telephone or landline telephone. The called/calling device need not be another telephone, however, it may be some other device such as an Internet web server, a content providing server, etc.

FIG. 7 represents a functional block diagram of the mobile telephone 10. For the sake of brevity, generally conventional features of the mobile telephone 10 will not be described in great detail. The mobile telephone 10 includes a primary control circuit 12 that is configured to carry out overall control of the functions and operations of the mobile telephone 1 0. The control circuit 12 may include a processing device 68, such as a CPU, microcontroller or microprocessor. The processing device 68 executes code stored in a memory (not shown) within the control circuit 12 and/or in a separate memory, such as memory 62, in order to carry out operation of the mobile telephone 1 0. The memory 62 may be, for example, one or more of a buffer, a flash memory, a hard drive, a removable media, a volatile memory, a non-volatile memory or other suitable device.

It will be apparent to a person having ordinary skill in the art of computer programming, and specifically in applications programming for mobile telephones or other electronic devices, how to program a video processing circuit 13 and the mobile telephone 10 to operate and carry out the functions described herein.

Continuing to refer to FIGS. 6 and 7, the mobile telephone 10 includes an antenna 70 coupled to a radio circuit 72. The radio circuit 72 includes a radio frequency transmitter and receiver for transmitting and receiving signals via the antenna 70 as is conventional. The radio circuit 72 may be configured to operate in a mobile communications system, as well as to receive data and/or audiovisual content or radio transmissions. For example, the receiver may be an IP datacast compatible receiver compatible with a hybrid network structure providing mobile communications and digital broadcast services, such as DVB-H mobile television and/or mobile radio. Other receivers for interaction with a mobile radio network or broadcasting network are possible and include, for example, GSM, CDMA, WCDMA, MBMS, WiFi, WiMax, DVB-H, ISDB-T, etc., as well as advanced versions of these protocols.

The mobile telephone 10 further includes a sound processing circuit 74 for processing audio signals transmitted by/received from the radio circuit 72. Coupled to the sound processing circuit 74 is a speaker(s) 76. Also coupled to the sound processing circuit 74 is a microphone 78 that enables a user to speak via the mobile telephone 10 as is conventional. The radio circuit 72 and sound processing circuit 74 are each coupled to the control circuit 12 so as to carry out overall operation. Audio data may be passed from the control circuit 12 to the sound processing circuit 74 for playback to the user via the speaker 76. The audio data may include, for example, audio data from an audio file stored by the memory 62 and retrieved by the control circuit 12, or an audio file or other media file remotely stored from the mobile telephone 10 and accessed or received by the radio circuit 72 or another conventional means. The sound processing circuit 74 may include any appropriate buffers, decoders, amplifiers, and so forth.

The mobile telephone 10 also includes the aforementioned display 18 and keypad 60 coupled to the control circuit 12. The display 18 may be coupled to the control circuit 12 by a video processing circuit 13 that converts video data to a video signal used to drive the display 18. The video data may be generated by the control circuit 12, retrieved from a video file that is stored in the memory 62, derived from an incoming video data stream received by the radio circuit 72 or obtained by any other suitable method.

The mobile telephone 10 further includes one or more I/O interface(s) 80. The I/O interface(s) 80 may be in the form of typical mobile telephone I/O interfaces and may include one or more electrical connectors. As is typical, the I/O interface(s) 80 may be used to couple the mobile telephone 10 to a battery charger to charge a battery of a power supply unit (PSU) 82 within the mobile telephone 1 0. In addition, or in the alternative, the I/O interface(s) 80 may serve to connect the mobile telephone 10 to a wired personal hands-free adaptor (not shown), such as a headset to audibly output sound signals output by the sound processing circuit 74 to the user. Further, the I/O interface(s) 80 may serve to connect the mobile telephone 10 to a personal computer or other device via a data cable. The mobile telephone 10 may receive operating power via the I/O interface(s) 80 when connected to a vehicle power adapter or an electricity outlet power adapter.

The mobile telephone 10 also may include a timer 84 for carrying out timing functions. Such functions may include timing the durations of calls, generating the content of time and date stamps, etc. The mobile telephone 10 may include a camera 86 for taking digital pictures and/or movies. Image and/or video files corresponding to the pictures and/or movies may be stored in the memory 62. The mobile telephone 10 also may include a position data receiver 88, such as a global positioning system (GPS) receiver, Galileo satellite system receiver or the like. The mobile telephone 10 also may include a local wireless interface 90, such as an infrared transceiver and/or an RF adaptor (e.g., a Bluetooth adapter), for establishing communication with an accessory, a hands-free adaptor (e.g., a headset that may audibly output sounds corresponding to audio data transferred from the mobile telephone 10 to the adapter), another mobile radio terminal, a computer or another device.

The mobile telephone 10 may be configured to transmit, receive and process data, such as text messages (e.g., colloquially referred to by some as “an SMS”), electronic mail messages, multimedia messages (e.g., colloquially referred to by some as “an MMS”), image files, video files, audio files, ring tones, streaming audio, streaming video, data feeds (including podcasts) and so forth. Processing such data may include storing the data in the memory 62, executing applications to allow user interaction with data, displaying video and/or image content associated with the data, outputting audio sounds associated with the data and so forth.

The control circuit 12 may be configured to access a media library 14. The media library 14 may access one or more media files 16 stored within the memory 62 or located remote from the mobile telephone 10 and accessed via the radio circuit 72, or another suitable means, as will be appreciated by one in the art. The media files 16 may be any type of audio/visual file, for example including, but not limited to, .avi, .mpeg, .mpeg-2 .mp3, .mp4, .midi, jpg, jpeg, .ppt, streaming video, etc. The sound processing circuit 74 may operate to process the content of the audio files into an audible signal that can be played through the speaker 76. Likewise, the video processing circuit 13 may operate to process the image or video files to produce images or video on the display 18. Both the sound processing circuit 74 and the video processing circuit 13 may be used at the same time for reproducing media files that contain both audio and video coding. The sound and video processing may be performed by any conventional processing circuit or device or may be combined into a single processor, as will be appreciated by one of skill in the art.

With additional reference to FIG. 8, the mobile telephone 10 may be configured to operate as part of a communications system 91. The system 91 may include a communications network 92 having a server 94 (or servers) for managing calls placed by and destined to the mobile telephone 10, transmitting data to the mobile telephone 10 and carrying out any other support functions. The server 94 communicates with the mobile telephone 10 via a transmission medium. The transmission medium may be any appropriate device or assembly, including, for example, a communications tower, another mobile telephone, a wireless access point, a wired access point, a satellite, etc. Portions of the network may include wireless transmission pathways. The network 92 may support the communications activity of multiple mobile telephones 10, although only one mobile telephone 10 is shown in the illustration of FIG. 7.

In one embodiment, the server 94 may operate in stand alone configuration relative to other servers of the communications network 92 or may be configured to carry out multiple communications network functions. As will be appreciated, the server 94 may be configured as a typical computer system used to carry out server functions and may include a processor configured to execute software containing logical instructions that embody the functions of the server 94.

Although described with respect to an electronic equipment, it will also be appreciated that the composite image and any associated video processing may be accomplished remote from the electronic equipment, for example, with a stand-alone computer, server, etc., and such composite image may be transferred to the electronic equipment in the information contained within the media file or via separate communication mechanism. The term “video pattern thumbnail” may also be used interchangeably with the term “composite image.”

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. An electronic equipment comprising:
a control circuit having access to a media file, the media file comprising frame data for a plurality of frames wherein the frame data for each of the plurality of frames represents a corresponding image comprising an array of pixel data;
a processor for extracting a portion of the frame data from each of the plurality of frames to produce data representing a composite image, the composite image comprising portions of frame data from each of the plurality of frames.

2. The electronic equipment of claim 1, wherein the plurality of frames are in a chronological order.

3. The electronic equipment of claim 2, wherein the extracted portion of the frame data from each frame comprises a column of pixel data from the array of pixel data for the frame.

4. The electronic equipment of claim 3, wherein the data representing the composite image comprises columns of pixel data from each of the plurality of frames arranged side-by-side and in chronological order.

5. The electronic equipment of claim 4, further comprising a display to view the composite image.

6. The electronic equipment of claim 5, wherein the display has a display area comprised of an array of pixels.

7. The electronic equipment of claim 6, wherein the array of pixels is comprised of a plurality of pixel columns.

8. The electronic equipment of claim 7, wherein number of columns of pixel data is the same as the number of columns of pixels in the display.

9. The electronic equipment of claim 1, further comprising a display to view the composite image.

10. The electronic equipment of claim 10, wherein the electronic equipment further comprises a media library for storing a media files to view on the display.

11. The electronic equipment of claim 10, wherein the medial library comprises the composite images for the medial files in the media library.

12. The electronic equipment of claim 11, wherein the media library further comprises a progress bar for indicating the portions of the media file that have been accessed by a media player.

13. The electronic equipment of claim 1, wherein each array of pixel data comprises a plurality of rows of pixel data and the extracted portions of the frame data represent the dominant color of the pixel data from each row.

14. The electronic equipment of claim 13, wherein the data representing the composite image comprises a plurality of columns of pixel data arranged side-by-side and in a chronological order.

15. The electronic equipment of claim 14, further comprising a display to view the composite image.

16. The electronic equipment of claim 1, wherein the media file comprises a video file.

17. The electronic equipment of claim 1, wherein the media file comprises a sequence of image files.

18. The electronic equipment of claim 1, wherein the media file representative of an audio file.

19. The electronic equipment of claim 1, wherein the electronic equipment is a mobile communication device.

20. A method of creating an image comprising the steps of:
accessing a media file, the media file comprising frame data for a plurality of frames wherein the frame data for each of the plurality of frames represents a corresponding image comprising an array of pixel data;
extracting a portion of the frame data from each of the plurality of frames to produce data representing a composite image, the composite image comprising portions of frame data from each of the plurality of frames.

21. The method of claim 20, wherein the step of extracting frame data comprises extracting a column of pixel data from each of the plurality of frames.

22. The method of claim 21, further comprising the step of arranging the pixel data side-by-side in chronological order.

23. The method of claim 22, further comprising the step of displaying the composite image on a display.

24. The method of claim 23, wherein the step of displaying the composite image comprises displaying the composite image on a screen comprised of an array of pixels.

25. The method of claim 24, wherein the step of displaying further comprises displaying the composite image with a screen comprised of an array of pixels having a plurality of pixel columns.

26. The method of claim 25, wherein the step of displaying the composite image on the screen further comprises displaying each extracted column of pixel data with a corresponding pixel column on the screen.

27. The method of claim 23, further comprising the step of indicating the portions of a media file that have been accessed by a media player function.

28. A program stored on a machine readable medium which, when executed by a machine, provides for the creation of an image by:
accessing a media file, the media file comprising frame data for a plurality of frames wherein the frame data for each of the plurality of frames represents a corresponding image comprising an array of pixels;
extracting a portion of the frame data from each of the plurality of frames to produce data representing a composite image comprised of portions of frame data from each of the plurality of frames.
